(19) United States
(12) Patent Application Publication
(10) Pub. No.: US 2020/0153383 A1
(43) Pub. Date: May 14, 2020

(54) Solar Cell Arrangement for an Electrically Drivable Motor Vehicle, and Motor Vehicle

(71) Applicant: Ford Global Technologies, LLC, Dearborn, MI (US)

(72) Inventors: Sebastian Stauff, Cologne (DE); Bruno Alves, Huerth (DE); Tobias Ricke, Cologne (DE)

(73) Assignee: Ford Global Technologies, LLC, Dearborn, MI (US)

(21) Appl. No.: 16/677,876

(22) Filed: Nov. 8, 2019

(30) Foreign Application Priority Data
Nov. 8, 2018 (DE) 102018219097.6

(51) Int. Cl. H02S 30/20; H02S 20/30; B60J 11/04; B60L 8/00

(52) U.S. Cl. CPC H02S 30/20; B60L 8/003; B60J 11/04; H02S 20/30

(57) ABSTRACT

The invention concerns a solar cell arrangement (2, 8) for an electrically drivable motor vehicle (1, 7), having at least one flexible structure (3, 10), at least one inflatable chamber (4) which is arranged or formed on the flexible structure (3, 10), at least one solar cell unit (6) arranged on the flexible structure (3, 10), and at least one transfer device connected to the chamber (4) for transferring the flexible structure (3, 10) from a slack stowage state into a tensioned function state. In order to provide a more effective solar cell arrangement (2, 8), at least one element of a shape-memory polymer is arranged on the flexible structure (3, 10), and/or the flexible structure (3, 10) is formed at least partially from a shape-memory polymer, and/or a wall of the chamber (4) is formed at least partially from a shape-memory polymer.

The invention concerns a solar cell arrangement for an electrically drivable motor vehicle, having at least one flexible structure, at least one inflatable chamber which is arranged or formed on the flexible structure, at least one solar cell unit arranged on the flexible structure, and at least one transfer device connected to the chamber for transferring the flexible structure from a slack storage state into a tensioned function state. The invention furthermore concerns a motor vehicle with at least one electric drive device.

An electrically drivable motor vehicle, in particular an electric vehicle, or its electric drive energy accumulator can be electrically charged by means of solar cells arranged on the motor vehicle. The problem is that the surface of a motor vehicle available for fitting the solar cells is relatively restricted and therefore not sufficiently large.

US 2012/0 146 358 A1 discloses a protective tarpaulin system for a motor vehicle. This system has a flexible tarpaulin for at least partially covering and protecting the motor vehicle, wherein the tarpaulin defines a longitudinal direction which extends in the longitudinal direction over the vehicle. The tarpaulin is provided with at least one stiffening element which extends substantially in the longitudinal direction and gives a certain stiffness to the flexible tarpaulin, in order to facilitate the process of covering the motor vehicle with the tarpaulin.

U.S. Pat. No. 7,984,746 B2 discloses a system for extending a cover under activation by an active material. The system has a mechanical arrangement with a plurality of mutually connected parts which are fixedly coupled to the cover and can be switched between an extended and a stowed state, wherein the cover is also extended and stowed. The system furthermore comprises an actuator with an element of an active material which can be operated to undergo a change when activated. The actuator is connected for drive purposes to the arrangement, and configured to transmit a linear translation force to at least one of the parts, in order to cause the at least one part to move in translational fashion as a result of the change and switch the arrangement between the extended and the stowed state because of the translational movement of the at least one part. The actuator has a slider which can be moved in a linearly translational fashion, wherein the element is an SMA wire which can be operated to cause the slider to move in translational fashion because of the change. The actuator furthermore comprises an antagonistic element which is configured to reverse the translational movement of the slider. The cover is brought to extend because of the translational movement of the slider, and to stow itself when the translational movement of the slider is reversed. The SMA wire and the antagonistic element are coupled to the slider. The arrangement furthermore comprises a T-shaped frame which is fixedly connected to the cover and connected pivotably to the slider, wherein the cover is brought to extend by handling of the frame.

CN 203 580 587 U discloses a flexible solar cell cover for a motor vehicle. The flexible solar cell cover has an auto-covering fabric, a plurality of flexible thin-layer solar cells, a central shaft and a coil spring, wherein the flexible thin-layer solar cells are arranged on the auto-covering fabric, the central shaft is arranged on a rear bumper or in a luggage compartment, the coil spring and the central shaft are fixed, one edge of the auto-covering fabric is attached to the central shaft, and a hook is arranged at an edge of the auto-covering fabric parallel to the center shaft and attached to a front bumper of the motor vehicle when the flexible solar cell cover is unfolded.

FR 2 941 200 A1 discloses a shield for a motor vehicle with a set of organic solar cells connected in series, wherein the shield covers the motor vehicle partly or completely when the shield is in an extended position. An unoccupied zone has no solar cells and is permeable to solar irradiation. A hook unit cooperates with a fixing unit on a side and/or a bumper of the motor vehicle so that the shield is held in the extended position. A connector of the shield is attached to a connector of a battery of the motor vehicle.

U.S. Pat. No. 9,815,359 B2 discloses an automated vehicle solar protection with a chamber which can be mounted on a roof of the vehicle, a flexible shield, a plurality of rods coupled to the flexible shield, a drive device coupled to the plurality of rods, and a spindle which is coupled to the flexible shield and can be actuated by the drive device. The plurality of rods can be retracted and extended so that the solar protection can be repeatedly switched between an extended position and a retracted position. In the retracted position, the flexible shield, the plurality of rods and the drive device are enclosed in the chamber. The solar protection also turns the spindle by actuation of the drive device to ensure that the solar protection can be extended and retracted without catching and tearing, and to easily fit in the compartment.

CN 106 476 591 A discloses a portable motor vehicle solar shield with a protective upper shell, wherein a hollow support is arranged vertically in the middle of the protective upper shell in a penetrating fashion. An upper outlet of the hollow support is connected to a lower air outlet of an inflation pump. A storage battery is fixedly arranged on the top of the inflation pump and conductively connected to the inflation pump. A solar cell panel is arranged on the top of the accumulator. The storage battery is used to store electrical energy which is converted from solar energy by the solar cell panel and provides working power for the inflation pump. The hollow support is connected to a solar shield retraction mechanism which is driven by the inflation pump in order to expand the fabric of the solar shield, and the fabric of the solar shield retracts when the inflation pump is switched off.

CN 206 086 320 U discloses a foldable sun protection panel with solar cells for a motor vehicle.

The invention is based on the object of providing a more effective solar cell arrangement of the type cited initially.

According to the invention, the object is achieved by a solar cell arrangement with the features of claim 1, in which at least one element of a shape-memory polymer is arranged on the flexible structure, and/or the flexible structure is formed at least partially from a shape-memory polymer, and/or a wall of the chamber is formed at least partially from a shape-memory polymer.

It is pointed out that the features and measures listed individually in the description below may be combined in any technically sensible fashion and indicate further embodiments of the invention. The description characterizes and specifies the invention further, in particular in conjunction with the figures.

According to the invention, the flexible structure is optimally tensioned and stiffened in its tensioned function state by the use of a shape-memory polymer, whereby for example undesirable folding or similar of the flexible structure can be reliably prevented. In particular, by the additional stiffening of the flexible structure according to the invention, for example a larger flexible structure may be used which allows the use of a larger number of solar cells in the solar cell arrangement, which in turn is associated with a higher energy gain, and a desired charging of the electric drive energy store of the motor vehicle takes less time. Overall therefore, the solar cell arrangement according to the invention is more effective than conventional arrangements.

Depending on application, the shape-memory polymer may be arranged at different locations of the solar cell arrangement. The shape-memory polymer may be stimulated for example by a temperature change.

The element arranged on the flexible structure and made of a shape-memory polymer is a separately produced element attached to the flexible structure.

The flexible structure may for example be formed from a shape-memory polymer at fold lines of the flexible structure in its tensioned state. The flexible structure may consist partly or completely for example of a fabric, a plastic or a fabric-reinforced plastic material. The solar cell arrangement according to the invention may also have two or more corresponding flexible structures.

The chamber may for example run along a fold line of the flexible structure in its tensioned function state and thus act as a support. The wall of the chamber may be formed at least partially from the flexible structure. Alternatively, the wall of the chamber may be produced separately and connected to the flexible structure. The solar cell arrangement according to the invention may also have two or more corresponding chambers.

The solar cell unit may have several solar cells and also be formed flexibly. The solar cell arrangement according to the invention may also have two or more solar cell units arranged on the flexible structure.

The transfer device may be connected to the inflatable chamber via a line and/or an actuatable valve unit. The transfer device may comprise at least one electrically controllable fan unit which is connected to the inflatable chamber. By means of the valve unit, the transfer device may for example maintain the pressure in the inflated chamber in order to hold the flexible structure in the tensioned function state without the need to keep the fan unit activated for this.

The above object is also achieved by a motor vehicle with the features of claim 2, which comprises at least one solar cell arrangement according to any of the embodiments cited above or a combination of at least two of these embodiments.

The advantages outlined above in connection with the solar cell arrangement are also associated correspondingly with the motor vehicle. The motor vehicle may in particular be a car. The motor vehicle may in particular be an electric vehicle.

According to an advantageous embodiment, the flexible structure is arranged and configured such that in the tensioned function state, it forms a hood covering the motor vehicle from the top and at the side. The hood may enclose the motor vehicle almost completely at the top and at the side in order to form a hood with as large a surface area as possible, which allows the use of a large number of solar cell units. The hood also protects the passenger compartment from solar irradiation and an associated heating.

A further advantageous embodiment provides that the flexible structure is arranged and configured such that in the tensioned function state, it forms a large-area screen on an inside of a vehicle window facing a passenger compartment of the motor vehicle. In this way, the flexible structure in its tensioned function state, the solar cell unit arranged thereon, and the chamber arranged on the flexible structure are arranged inside the passenger compartment so as to be protected and secure against vandalism, and protected from the weather. Due to the flexible structure present in its tensioned function state and formed for example as a wall or similar, the passenger compartment is also protected from solar irradiation through the vehicle window and an associated heating.

According to a further advantageous embodiment, the motor vehicle comprises at least one storage space for storing the flexible structure in its slack storage state, and at least one retraction device for retracting the flexible structure in its slack storage state into the storage space. The flexible structure, with the components of the solar cell arrangement arranged thereon, is arranged inside the storage space so as to be protected during travel of the motor vehicle. The retraction device may for example have at least one electrically actuatable winding unit onto which the flexible structure, in its slack storage state, can be wound for retraction into the storage space.

According to a further advantageous embodiment, the storage space is arranged in a roof region of the motor vehicle. This is advantageous in particular if the flexible structure is arranged and formed such that, in the tensioned function state, it forms a hood covering the motor vehicle from the top and at the side. The solar cell arrangement here may for example comprise two or more flexible structures which may be deployed from the storage space in different directions. The storage space may be formed for example in the manner of a roof box or similar.

According to a further advantageous embodiment, the motor vehicle has at least one vehicle electronics connected to the transfer device and the retraction device, and configured to actuate the transfer device during a parked condition of the motor vehicle, in order to automatically transfer the flexible structure, which is fully present in the storage space, from the slack stowage state into the tensioned function state, and thereby move the flexible structure out of the storage space, and after receiving a signal indicating an impending end of the parked situation, to actuate the retraction device to automatically retract the flexible structure, again in its slack stowage state, completely back into the storage space. In this way, a fully automated actuation of the solar cell arrangement is possible, so that the handling of the motor vehicle is not adversely affected by the presence of the solar cell arrangement. The signal indicating an impending end of the parked condition may for example be a previously stored starting time or a radio signal from a radio remote control of the motor vehicle.

Further advantageous embodiments of the invention are given in the subclaims and the following description of the figures. The drawing shows:

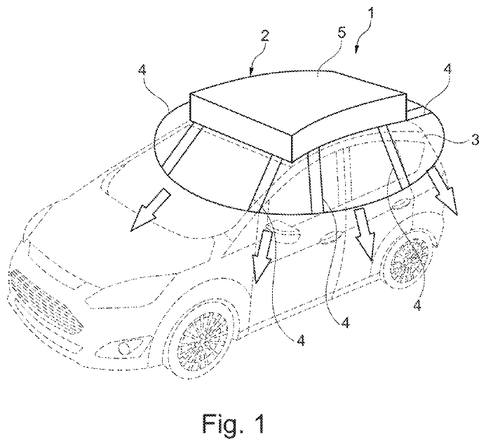

FIG. 1 a diagrammatic and perspective depiction of an exemplary embodiment of a motor vehicle according to the invention with partially extended solar cell arrangement,

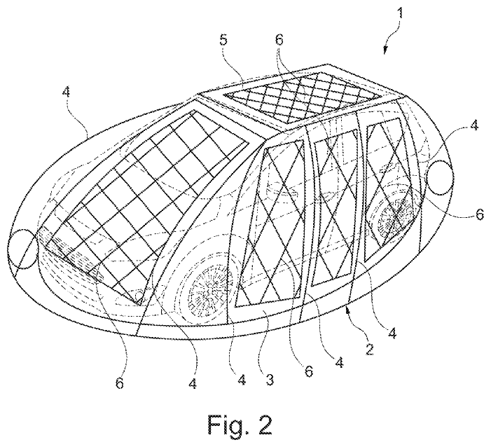

FIG. 2 a diagrammatic and perspective depiction of the motor vehicle shown in FIG. 1 with fully extended solar cell arrangement, and

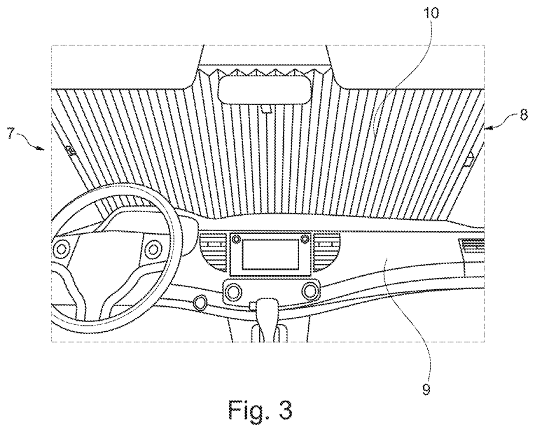

FIG. 3 a diagrammatic depiction of a further exemplary embodiment of a motor vehicle according to the invention with fully extended solar cell arrangement.

In the different figures, the same parts always carry the same reference signs so these are usually only described once.

FIG. 1 shows a diagrammatic and perspective depiction of an exemplary embodiment of an electrically drivable motor vehicle 1 according to the invention with partially extended solar cell arrangement 2. The motor vehicle 1 also has at least one electric drive device (not shown).

The solar cell arrangement 2 has a flexible structure 3, several inflatable hose-like chambers 4 arranged or formed on the flexible structure 3, several solar cell units arranged on the flexible structure 3 and shown in FIG. 2, and a transfer device (not shown) connected to the chambers 4, for transferring the flexible structure 3 from a slack storage state into a tensioned function state shown in FIG. 2.

At least one element (not shown) made of a shape-memory polymer is arranged on the flexible structure 2, and or the flexible structure 3 is formed at least partially from a shape-memory polymer, and/or a wall (not shown) of the respective chamber 4 is made at least partially from a shape-memory polymer. The flexible structure 3 is arranged and configured such that, in the tensioned function state shown in FIG. 2, it forms a hood covering the motor vehicle 1 completely from the top and at the side.

In a roof region, the motor vehicle 1 has a storage space 5 for storing the flexible structure 3 in its slack storage state, and a retraction device (not shown) for retracting the flexible structure 3 in its slack storage state into the storage space 5.

The motor vehicle 1 also has a vehicle electronics (not shown) connected to the transfer device and the retraction device, which is configured to actuate the transfer device during a parked condition of the motor vehicle 1 in order to automatically transfer the flexible structure 3, fully present in the storage space 5, from the slack storage state into the tensioned function state, and thereby move the flexible structure 3 out of the storage space 5, and to actuate the retraction device after receiving a signal indicating an impending end of the parked condition, in order to automatically retract the flexible structure 3, again in its slack stowage state, completely back into the storage space 5.

FIG. 2 shows a diagrammatic and perspective view of the motor vehicle 1 shown in FIG. 1 with fully extended solar cell arrangement 2. The solar cell arrangement 2 forms the hood described above. The shape-memory polymer also serves to completely expand the flexible structure 3 with solar cell units 6 arranged thereon.

FIG. 3 shows a diagrammatic depiction of a further exemplary embodiment of a motor vehicle 7 according to the invention with fully extended solar cell arrangement 8. A view of the passenger compartment of the motor vehicle 1 is shown. In particular, the dashboard 9 of the motor vehicle 7 is shown, over which the windscreen is arranged which is covered by the solar cell arrangement 8 and therefore not visible.

In contrast to the exemplary embodiment shown in FIGS. 1 and 2, with the solar cell arrangement 8 according to FIG. 3, the flexible structure 10 is arranged and configured such that, in the tensioned function state shown in FIG. 3, it forms a large-area screen on an inside of the vehicle window (not shown) facing the passenger compartment of the motor vehicle 1.

The solar cell unit of the solar cell arrangement 8 is arranged on the side of the flexible structure 10 facing away from the viewer in FIG. 3, and is not therefore visible. The motor vehicle 7 may have a storage space (not shown) above or below the vehicle window for storage of the flexible structure 10 in its slack storage state.

Otherwise, the motor vehicle 7 may be formed according to the exemplary embodiment shown in FIGS. 1 and 2. To avoid repetition, reference is made to the above description in relation to FIGS. 1 and 2.

### LIST OF REFERENCE SIGNS

1 Motor vehicle
2 Solar cell arrangement
3 Flexible structure
4 Inflatable chamber
5 Storage space
6 Solar cell unit
7 Motor vehicle
8 Solar cell arrangement
9 Dashboard
10 Flexible structure

1. A solar cell arrangement (2, 8) for an electrically drivable motor vehicle (1, 7), the solar cell arrangement comprising:
at least one flexible structure (3, 10),
at least one inflatable chamber (4) which is arranged or formed on the at least one flexible structure (3, 10),
at least one solar cell unit (6) arranged on the at least one flexible structure (3, 10), and
at least one transfer device connected to the at least one inflatable chamber (4) for transferring the at least one flexible structure (3, 10) from a slack stowage state into a tensioned function state,
wherein at least one element of a shape-memory polymer is arranged on the at least one flexible structure (3, 10), the at least one flexible structure (3, 10) is formed at least partially from the shape-memory polymer, and/or a wall of the at least one inflatable chamber (4) is formed at least partially from the shape-memory polymer.

2. A motor vehicle (1, 7), comprising:
at least one electric drive device, and
a solar cell arrangement (2, 8), the solar cell arrangement comprising:
at least one flexible structure (3, 10),
least one inflatable chamber (4) which is arranged or formed on the at least one flexible structure (3, 10),
at least one solar cell unit (6) arranged on the at least one flexible structure (3, 10), and
at least one transfer device connected to the at least one inflatable chamber (4) for transferring the at least one flexible structure (3, 10) from a slack stowage state into a tensioned function state,
wherein at least one element of a shape-memory polymer is arranged on the at least one flexible structure (3, 10), the at least one flexible structure (3, 10) is formed at least partially from the shape-memory polymer, and/or a wall of the at least one inflatable chamber (4) is formed at least partially from the shape-memory polymer.

3. The motor vehicle (1) according to claim 2, wherein:
the at least one flexible structure (3) is arranged and configured such that in the tensioned function state, it forms a hood covering the motor vehicle (1) from a top and at a side.

4. The motor vehicle (7) according to claim 2, wherein:
the at least one flexible structure (8) is arranged and configured such that in the tensioned function state, it forms a large-area screen on an inside of a vehicle window facing a passenger compartment of the motor vehicle (7).

5. The motor vehicle (1, 7) according to claim 2, wherein:
at least one storage space (5) for storing the at least one flexible structure (3, 10) in its slack storage state, and at least one retraction device for retracting the at least one flexible structure (3, 10) in its slack storage state into the at least one storage space (5).

6. The motor vehicle (1, 7) according to claim 5, wherein:
the at least one storage space (5) is arranged in a roof region of the motor vehicle (1, 7).

7. The motor vehicle (1, 7) according to claim 5, wherein:
at least one vehicle electronics is connected to the at least one transfer device and the at least one retraction device and is configured:
to actuate the at least one transfer device during a parked condition of the motor vehicle (1, 7) in order to automatically transfer the at least one flexible structure (3, 10), which is fully present in the at least one storage space (5), from the slack stowage state to the tensioned function state, and thereby move the at least one flexible structure (3, 10) out of the at least one storage space (5), and
after receiving a signal indicating an impending end of the parked condition, to actuate the at least one retraction device to automatically retract the at least one flexible structure (3, 10), again in its slack stowage state, completely back into the at least one storage space (5).
